(19) United States
(12) Patent Application Publication
(10) Pub. No.: US 2013/0166380 A1
(43) Pub. Date: Jun. 27, 2013

(54) USE OF SERVICE ADDRESS IDENTIFIER FOR ANONYMOUS USER INTERACTIONS

(71) Applicant: Manah Mounir Khalil, Irving, TX (US)

(72) Inventor: Manah Mounir Khalil, Irving, TX (US)

(73) Assignee: VERIZON PATENT AND LICENSING INC., Basking Ridge, NJ (US)

(21) Appl. No.: 13/336,003

(22) Filed: Dec. 23, 2011

(51) Int. Cl. G06Q 30/02

(52) U.S. Cl. 705/14.53; 705/14.66

(57) ABSTRACT

A device receives a first contact from a consumer, where the first contact is related to a service offered by a service provider. The device further obtains a physical service address associated with the consumer, and adds information associated with the contact to a consumer contacts profile associated with the physical service address. The device uses the consumer contacts profile to generate a service-related recommendation, or to select an advertisement, for presentation to the consumer.

### BACKGROUND

A “cookie,” also known as a browser cookie, can be used to return state information to a website being browsed by a user. The state information may be used for authentication, user session identification, identification of user shopping cart contents, etc. A cookie may be used to remember information about a user who has visited a website. In this case, the cookie may be a persistent cookie that outlasts user sessions. The website may receive the persistent cookie from the user's browser and may personalize pages of the website accessed by the user based on the information stored in the cookie.

### BRIEF DESCRIPTION OF THE DRAWINGS

FIG. 1 illustrates an exemplary overview of the use of a consumer's physical service address as an identifier in situations where the consumer contacts a service provider in an anonymous manner;

FIG. 2 depicts an exemplary network environment in which a consumer's physical service address is used as a service identifier in situations where the consumer contacts a service provider in an anonymous manner;

FIG. 3 is a diagram that depicts exemplary components of a service provider device of FIG. 2;

FIG. 4 is a diagram that depicts a data structure that may be stored in the service address identifier database of FIG. 2;

FIG. 5 is a diagram that depicts a data structure that may be stored in the tracking database of FIG. 2;

FIG. 6 is a diagram that depicts an exemplary process for receiving an initial anonymous contact and a physical service address from a consumer;

FIG. 7 is a diagram that depicts an example where a consumer provides the consumer's physical service address to a service provider via a computer and the Internet;

FIG. 8 is a diagram that graphically depicts the exemplary process of FIG. 6;

FIG. 9 is a flow diagram that illustrates an exemplary process for tracking a consumer's contacts with a service provider to accumulate information in a consumer contacts profile that may be subsequently used by the service provider in ascertaining the consumer's interests and purchasing habits;

FIGS. 10 and 11 are diagrams that graphically depict the exemplary process of FIG. 9;

FIG. 12 is a flow diagram that illustrates the use of information stored in the tracking database for ascertaining a consumer's interests or purchasing habits for generating a service-related recommendation(s) and/or for selecting an advertisement(s) for presentation to the consumer; and

FIG. 13 is a diagram that graphically depicts the exemplary process of FIG. 12.

### DETAILED DESCRIPTION OF THE PREFERRED EMBODIMENTS

The following detailed description refers to the accompanying drawings. The same reference numbers in different drawings may identify the same or similar elements. The following detailed description does not limit the invention.

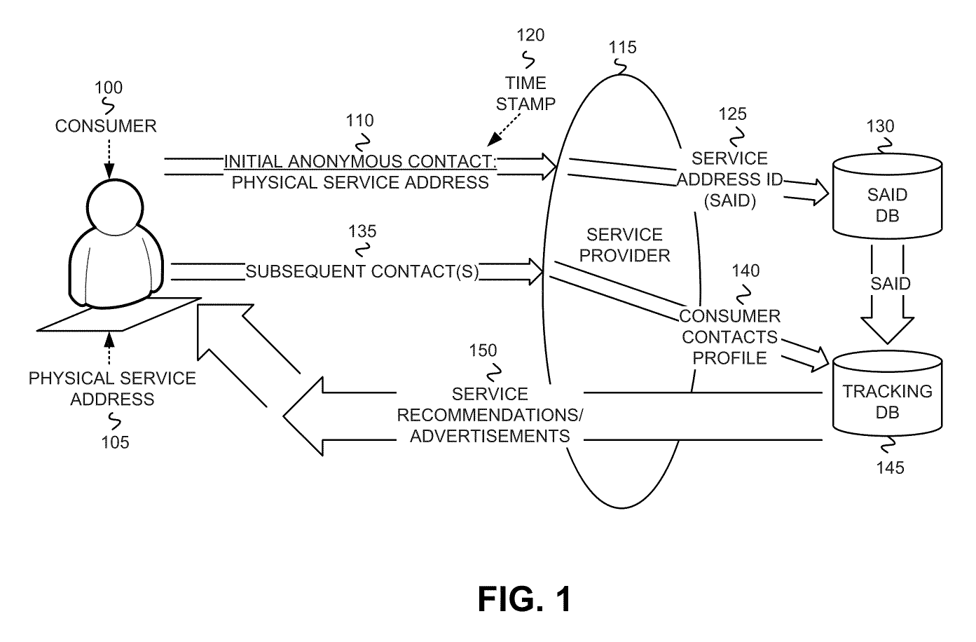

FIG. 1 illustrates an exemplary overview of the use of a consumer's physical service address as an identifier in situations where the consumer contacts a service provider in an anonymous manner. As shown in FIG. 1, a consumer 100, residing at a physical service address 105, may initiate an initial anonymous contact 110 with a service provider 115. Contact 110 may identify consumer 100's physical service address 105, and may involve consumer 100 shopping for a product or service from service provider 115. For example, consumer 100 may be shopping for the establishment of a service to consumer 100's physical service address 105. For example, physical service address 105 may be service consumer 100's home address or business address. Service provider(s) 115 may include any entity that requires knowledge of consumer 100's physical service address 105 to provide a service to consumer 100. For example, service provider(s) 115 may include a mail or package delivery service provider, a cable network service provider (i.e., a video delivery network), a telephone network service provider, an Internet service provider, or a utility service provider (e.g., electricity, gas, water, etc. Contact 100 may be made, for example, using a computer via a computer network (e.g., the Internet), using a telephone via a telephone network (e.g., Public Switched Telephone Network or cellular network), or using a set-top box via a cable network.

Upon receipt of contact 110, service provider 115 may generate a time stamp 120 that indicates a date and a time at which consumer 100 contacted service provider 115. Service provider 115 may generate a service address identifier (SAID) 125 based on physical service address 105 and time stamp 120, and may store SAID 125 in a SAID database (DB) 130. Other information may eventually be stored in SAID DB 130 in conjunction with SAID 125 after consumer 100 has established a formal account with service provider 115, including, for example, account information associated with consumer 100 (e.g., consumer's name, telephone number, etc.).

Subsequent to initial anonymous contact 110 between service provider(s) 115 and consumer 100, consumer 100 may initiate one or more subsequent contacts 135 with service provider(s) 115 in an anonymous manner. Consumer 100 may provide physical service address 105 to service provider 115 in conjunction with a contact 135, but may provide no other identifying information to service provider 115. Contact(s) 135 may include any type of contact between consumer 100 and a service provider 115 that is related to a service offered by service provider 115. For example, if service provider 115 is a telephone network service provider, than consumer 100 may contact service provider 115 to order a new telephone service (e.g., call waiting, unlimited long distance, etc.). In this case, service contact 135 may include all of the new telephone services that consumer 100 considers as candidates prior to ordering the new telephone service. As another example, if service provider 115 is a cable network service provider, than consumer 100 may contact service provider 115 to order one or more new services to add to their account, such as, for example, ordering premium movie channels or premium sports channels. In this case, contact 135 may include all of the premium channels that consumer 100 considers adding prior to ordering one or more of the premium channels.

Based on contact(s) 135, service provider(s) 115 may store information associated with contact(s) 135 as a consumer contacts profile 140 (e.g., a history of consumer contacts) in a tracking DB 145. Tracking DB 145 may store the consumer contacts profile 140 in association with consumer 100's physical service address 105. Tracking DB 145 may store other information, as described in further detail below. The information associated with service contact(s) 135 may be collected or generated in a number of different ways, depending on the means by which consumer 100 contacts service provider 115. For example, if consumer 100 contacts service provider 115 using a computer and a network connection, then a device associated with service provider 115 (e.g., a server) may monitor consumer 100's on-line activity when accessing and viewing web pages hosted by the device. As another example, if consumer 100 contacts service provider 115 using a telephone and a Public Switched Telephone Network connection, then a call center operator associated with service provider 115 may manually record the purpose of consumer 100's service contact, the types of services and/or products consumer 100 inquired about, etc.

Service provider(s) 115, using consumer contacts profile 140 stored in tracking DB 145, may present recommendations and/or advertisements 150 to consumer 100. Recommendations and/or advertisements 150 may, for example, be presented to consumer 100 at the time that consumer 100 initiates a contact 135 with service provider 115. For example, continuing with this scenario, if consumer 100 subsequently contacts service provider 115 again via the Internet, recommendations and/or advertisements 150 may be presented to consumer 100 via a web page. The recommendations and/or advertisements may be generated or selected based on their relevance to consumer 100's consumer contacts profile 140. For example, if consumer 100 has previously shopped on-line for a particular new cellular telephone, then recommendations may be generated for presentation to consumer 100 related to other cellular telephones having similar capabilities, or to accessories for the particular new cellular telephone. As another example, if consumer 100 has previously called a cable service provider's call center and inquired about a specific premium sports channel, then one or more other premium sports channels, having similar or related content, may be recommended to consumer 100. Alternatively, these recommendations or advertisements 150 could be presented to consumer 100 during the initial session with service provider 115.

In embodiments described herein, a service provider may, thus, associate a history of contacts between a consumer and the service provider based on the physical service address of the consumer, even when the consumer is establishing contacts anonymously. Over multiple contacts between the consumer and the service provider, the consumer contacts profile can accumulate the consumer's contact history to link other known identifiers for the same consumer to the consumer's physical service address. The consumer contacts profile can give the service provider better insight into the consumer's preferences and may be used for possible service-related recommendations, or for presenting advertisements to the consumer.

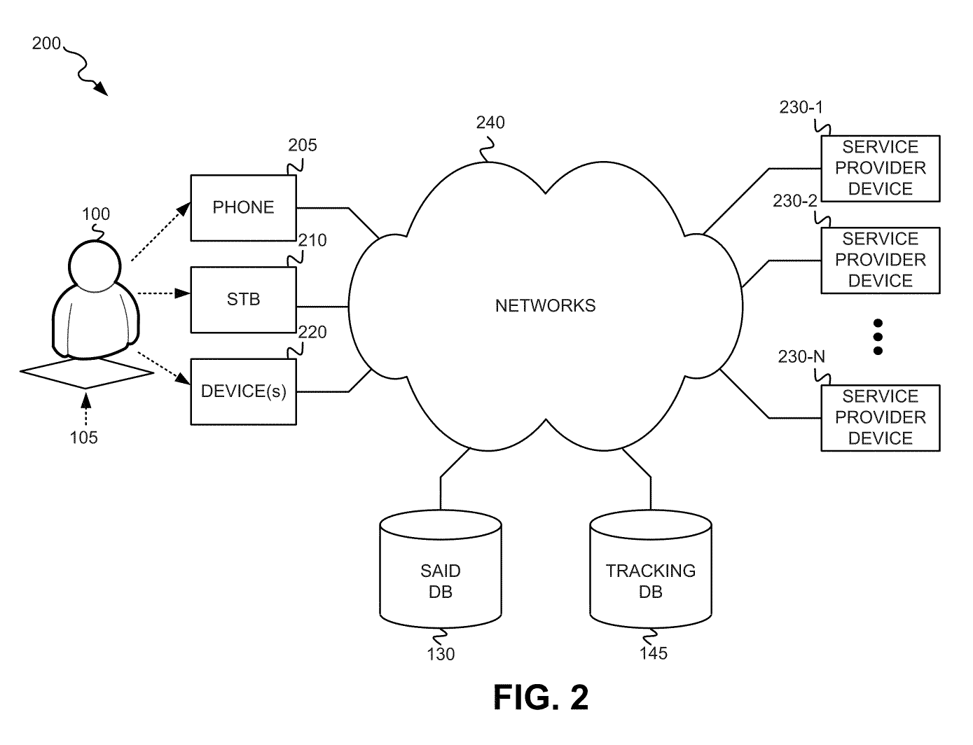

FIG. 2 depicts an exemplary network environment 200 in which a consumer's physical service address is used as a service identifier in situations where the consumer contacts a service provider in an anonymous manner. Network environment 200 may include a telephone 205, a set-top box (STB) 210, a device 220, service provider devices 230-1 through 230-N (also referred to collectively as service provider devices 230 or generically and individually as service provider device 230), SAID DB 130, tracking DB 145, and networks 240.

Telephone 205 may include any type of telephonic device used to communicate via a wired or wireless network. Telephone 205 may include a Plain Old Telephone System (POTS) telephone connected to a Public Switched Telephone Network (PSTN). Telephone 205 may also include any type of portable digital computing device that has the capability to communicate via a wireless network (e.g., via a mobile carrier network, WiFi, etc.). For example, telephone 205 may include a cellular telephone (e.g., a smart phone), a tablet computer, or a personal digital assistant (PDA) having wireless communication capability.

STB 210 may include a device that connects to a television (or other display device) and to an external source of signals via a network, and that tunes to channels on the network to display the signals as content on the television (or other display device). Device(s) 220 may include a desktop, a laptop, a tablet or a palmtop computer having connectivity to one or more networks of networks 240.

Each of service provider devices 230-1 through 230-N may include a network device, such as, for example, a server, that is associated with a specific service provider 115, and which may be involved in contacts with consumer 100. Each of service provider devices 230-1 through 230-N may receive contacts from phone 205, STB 210 or device(s) 220 via networks 240. For example, in one implementation, consumer 100 may, using phone 205, call service provider device 230 via a PSTN of networks 240 to request service at physical service address 105. An operator at the call center may manually enter service request information into service provider device 230, including physical service address 105 and other information. As another example, consumer 100 may, using device 220 (e.g., a tablet computer), contact service provider device 230 on-line to access an initial service request webpage. Consumer 100 may enter service request information into the service request webpage, and may submit the request via the Internet to service provider device 230.

SAID DB 130 may store multiple physical service address, identifiers corresponding to physical service addresses 105, and associated cookies, and account information received from service provider devices 230. Service provider devices 230 may access data stored in SAID DB 130 by indexing SAID DB 130 with a specific physical service address identifier.

Tracking DB 145 may store consumer contacts profile information associated with multiple different physical service addresses, and other information, such as, for example, cookies. Though only a single SAID DB 130 and tracking DB 145 is shown in FIG. 2, in some implementations, a different SAID DB 130 and tracking DB 145 may be associated with each of service provider devices 230-1 through 230-N.

Networks 240 may include multiple different networks of various types. For example, networks 240 may include a cable network (e.g., an optical cable network), a satellite network, a wireless public land mobile network (PLMN) (e.g., a Code Division Multiple Access (CDMA) 2000 PLMN, a Global System for Mobile Communications (GSM) PLMN, a Long Term Evolution (LTE) PLMN and/or other types of PLMNs), a telecommunications network (e.g., a Public Switched Telephone Network (PSTN)), a local area network (LAN), a wide area network (WAN), a metropolitan area network (MAN), an intranet, and/or the Internet.

The configuration of network components of network environment 200 illustrated in FIG. 2 is for illustrative purposes. Other configurations may be implemented. Therefore, network environment 200 may include additional, fewer and/or different components than those depicted in FIG. 2.

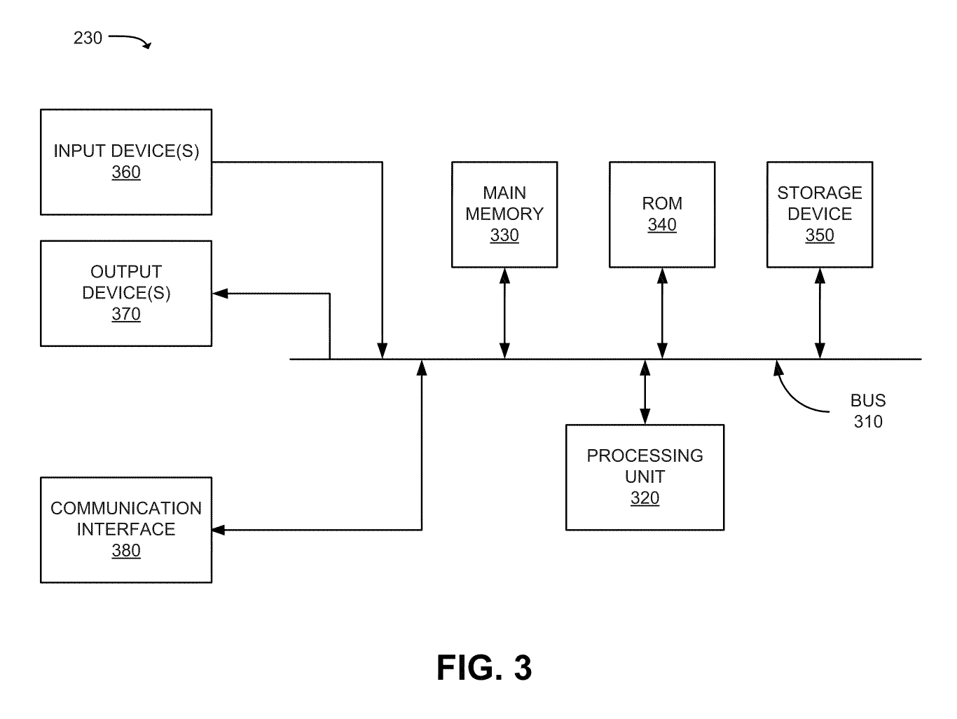

FIG. 3 is a diagram that depicts exemplary components of service provider device 230. Phone 205, STB 210 and device 220 may be similarly configured. Service provider device 230 may include a bus 310, a processing unit 320, a main memory 330, a read only memory (ROM) 340, a storage device 350, an input device(s) 360, an output device(s) 370, and a communication interface(s) 380. Bus 310 may include a path that permits communication among the components of device 230.

Processing unit 320 may include one or more processors or microprocessors, or processing logic, which may interpret and execute instructions. Main memory 330 may include a random access memory (RAM) or another type of dynamic storage device that may store information and instructions for execution by processing unit 320. ROM 340 may include a ROM device or another type of static storage device that may store static information and instructions for use by processing unit 320. Storage device 350 may include a magnetic and/or optical recording medium. Main memory 330, ROM 340 and storage device 350 may each be referred to herein as a “computer-readable medium.”

Input device 360 may include one or more mechanisms that permit an operator to input information to service provider device 230, such as, for example, a keypad or a keyboard, a display with a touch sensitive panel, voice recognition and/or biometric mechanisms, etc. Output device 370 may include one or more mechanisms that output information to the operator, including a display, a speaker, etc. Communication interface(s) 380 may include a transceiver that enables service provider device 230 to communicate with other devices and/or systems. For example, communication interface(s) 380 may include wired or wireless transceivers for communicating via networks 240.

The configuration of components of service provider device 230 illustrated in FIG. 3 is for illustrative purposes. Other configurations may be implemented. Therefore, service provider device 230 may include additional, fewer and/or different components than those depicted in FIG. 3.

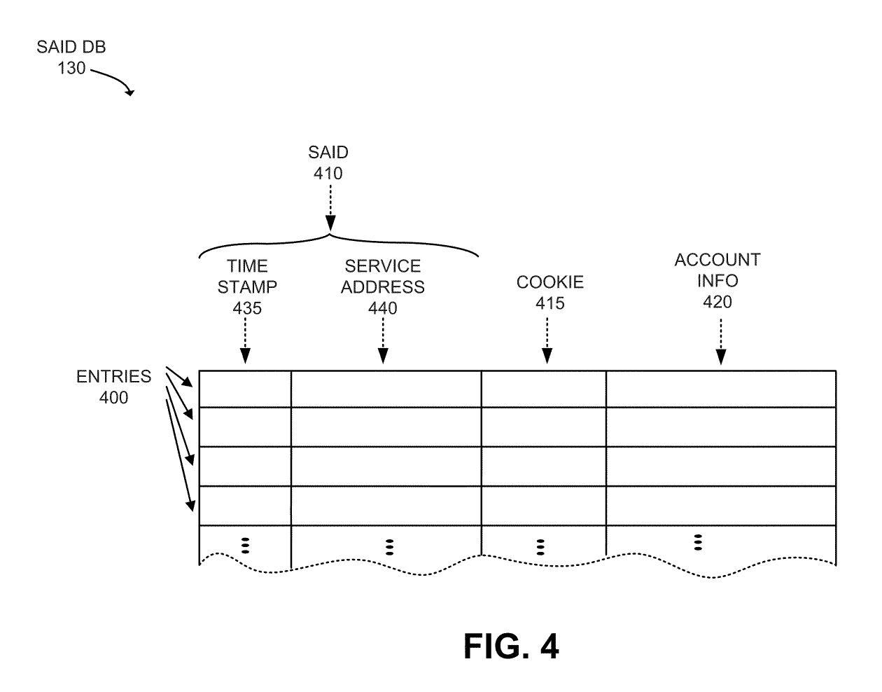

FIG. 4 is a diagram that depicts a data structure that may be stored in SAID DB 130. The data structure of SAID DB 130 may include multiple entries 400, with each entry further including a SAID field 410, a cookie field 415, an account information field 420, and a service flag field 430. SAID field 410 may further include a time stamp field 435 and a service address field 440.

Time stamp field 435 may identify a time at which a service provider receives a contact from a consumer. Service address field 440 may identify a physical service address at which a consumer resides (e.g., and at which the consumer may receive a service from service provider 115). The physical service address includes a residential or a commercial geographic address at which a service is provided by the service provider.

Cookie field 415 may store the consumer's cookie that may be used by service provider devices 230-1 through 230-N to identify the consumer when the consumer accesses service provider devices 230-1 through 230-N on-line via, for example, the Internet.

Account information field 420 may include information related to the consumer's service account with a service provider. Account information field 420 may, for example, store the consumer's telephone number, credit/debit card information, current service(s), and other service-related information for the consumer at a physical service address identified by service address field 440.

The number and content of the data fields of SAID DB 130 illustrated in FIG. 4 is for illustrative purposes. Other data structures, with more, fewer, or different data fields may be implemented. Therefore, SAID DB 130 may include additional, fewer and/or different data fields than those depicted in FIG. 4.

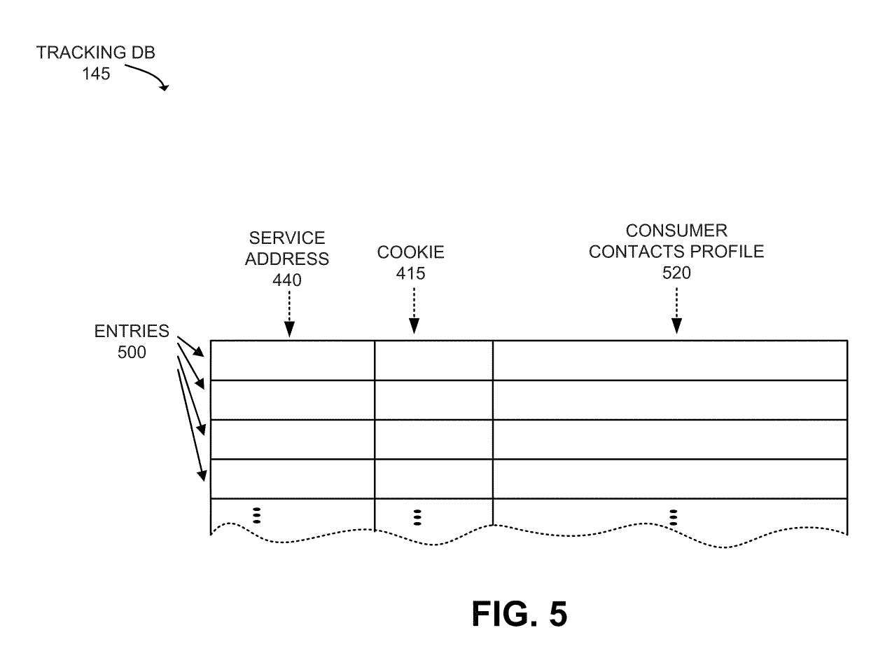

FIG. 5 is a diagram that depicts a data structure that may be stored in tracking DB 145. Tracking DB 145 may include multiple entries 500, with each entry 500 including a service address field 440, a cookie field 415, and a consumer contacts profile field 520. Consumer contacts profile field 520 may store profile information that indicates the consumer's contact history with service provider 115. The profile information may include web pages accessed, services and/or service-related products that the consumer considered purchasing, services previously subscribed to, etc. The profile information may include any type of information related to a consumer's contacts with service provider 115 that may be useful in identifying the consumer's interests, purchasing habits, etc.

The number and content of the data fields of tracking DB 145 illustrated in FIG. 5 is for illustrative purposes. Other data structures, with more, fewer, or different data fields may be implemented. Therefore, tracking DB 145 may include additional, fewer and/or different data fields than those depicted in FIG. 5.

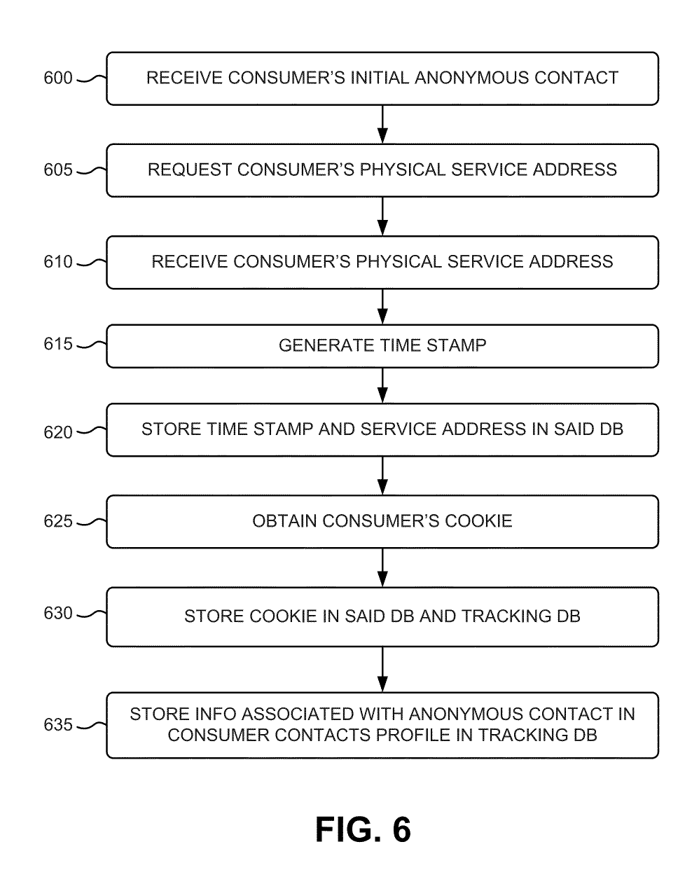

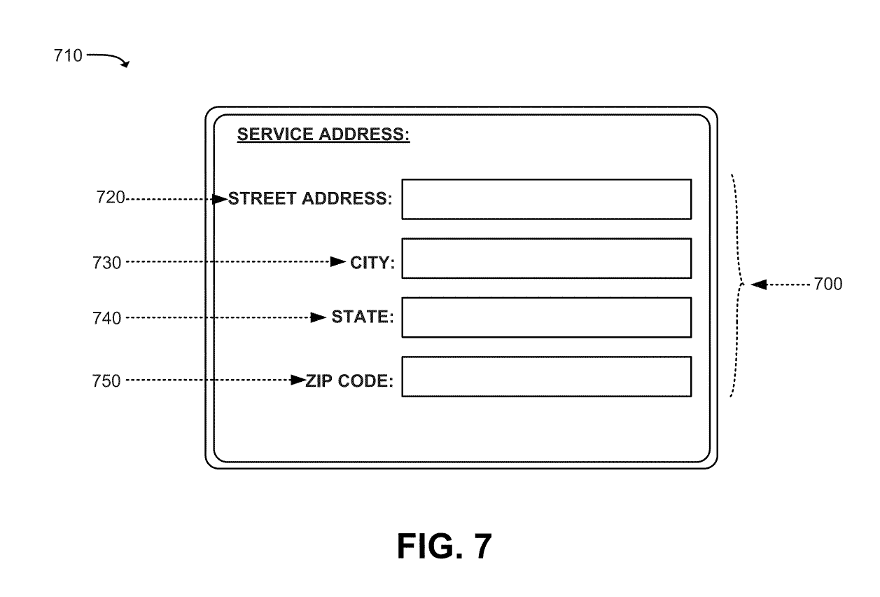

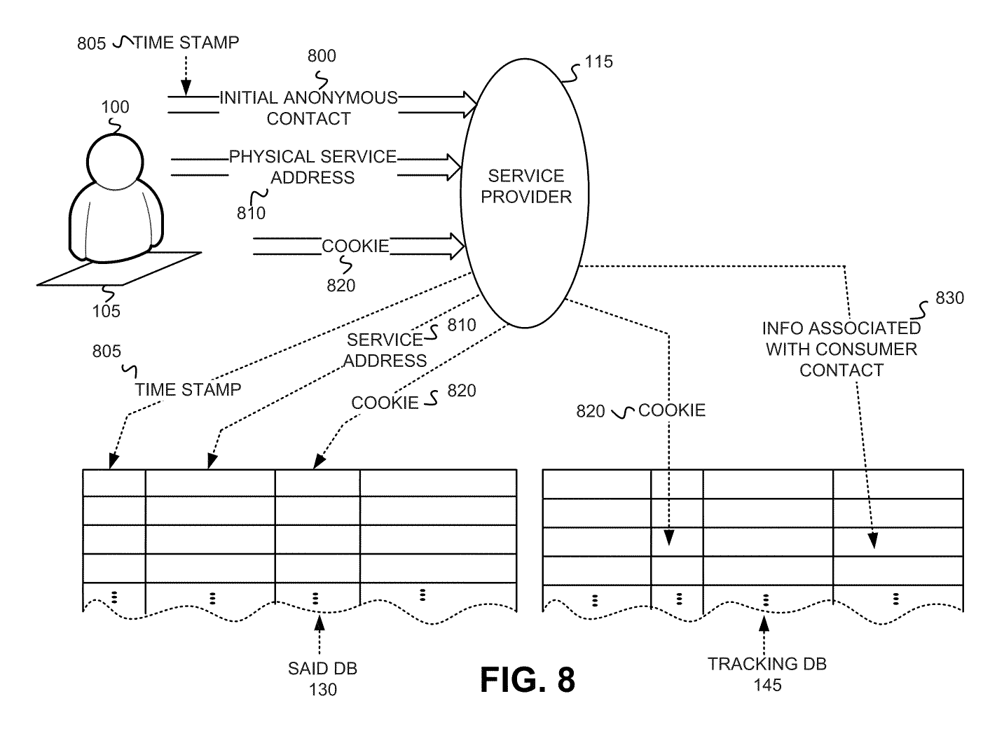

FIG. 6 is a diagram that depicts an exemplary process for receiving an initial anonymous contact and a physical service address from a consumer. The exemplary process of FIG. 6 may be implemented by service provide device 230. The exemplary process of FIG. 6 is described below with reference to FIGS. 7 and 8.

The exemplary process may include receiving a consumer's initial anonymous contact (block 600). The initial anonymous contact may involve the consumer shopping for a product or service from service provider 115. For example, the consumer may be shopping for the establishment of a service to the consumer's physical service address. The consumer may make the anonymous contact with service provider 115 via phone 205, STB 210 or device 220. For example, consumer 100 may use a desktop computer to access service provider device 230 via the Internet to make an anonymous contact via a web page. FIG. 8 depicts consumer 100, located at physical service address 105, initiating an anonymous contact 800 with service provider 115.

The physical service address associated with the request may be identified (block 605). As shown in FIG. 7, in an example in which consumer 100 has contacted service provider device 230 via a computer and the Internet, consumer 100 may enter his physical service address 700 into a web page 710 hosted by service provider device 230. Service address 700 may include, for example, a street address 720, a city 730, a state 740, and a zip code 750. FIG. 8 shows consumer 100 initiating the initial anonymous contact 800, wherein anonymous contact 800 includes physical service address 805.

Service provider device 230 may generate a time stamp (block 610). At the time that service provider device 115 receives the initial anonymous contact from consumer 100, service provider device 230 may generate a time stamp that includes the time, day and year at which the initial anonymous contact was received. FIG. 8 depicts a time stamp 810 being generated at the time that consumer 100 initiates anonymous contact 800.

Service provider device 230 may store the time stamp and the physical service address in SAID DB 130 (block 620). As shown in FIG. 8, service provider 115 may store the generated time stamp 805 in time stamp field 435 and the received physical service address 805 in service address field 440.

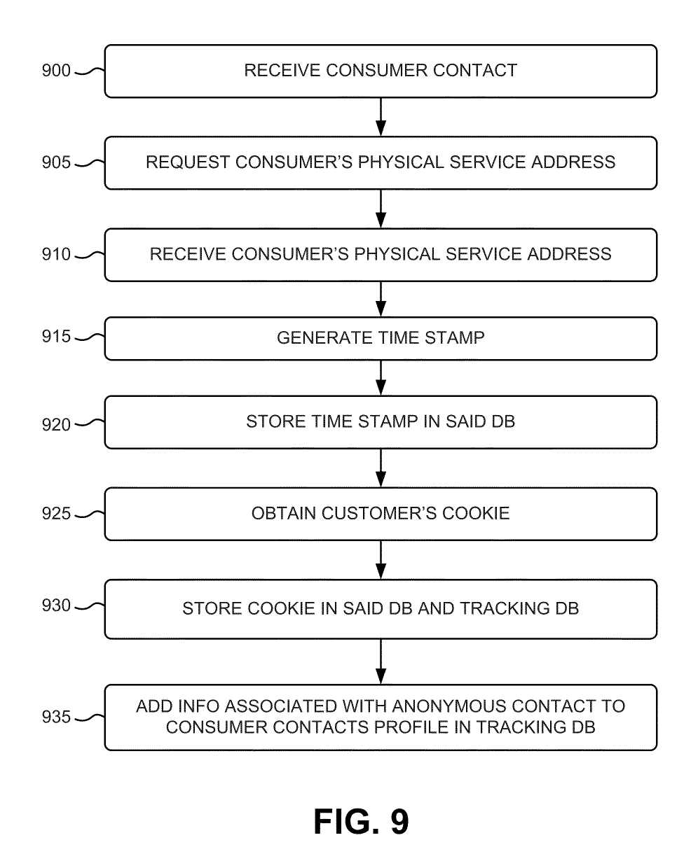

Service provider device 230 may obtain consumer 100's cookie associated with the consumer's use of STB 210 or device 220 (block 625) and may store the cookie in SAID DB 130 and tracking DB 145 (block 630). As shown in FIG. 8, service provider 115 may store the obtained cookie 830 in cookie field 415 of SAID DB 130 and tracking DB 145. Service provider device 230 may store information associated with consumer 100's anonymous contact in the consumer contacts profile field 520 that corresponds to the physical service address obtained in block 610 (block 635). The information associated with the contact may include any type of information related to the consumer's contact with the service provider. For example, if the consumer shops on-line for one or more new services to receive from the service provider, the information associated with the contact may include each of the one or more new services that the consumer viewed while on-line. FIG. 8 depicts service provider 115 (e.g., via service provider device 230) storing the information 830 associated with the contact in tracking DB 145. Subsequent to initial anonymous contact 800, consumer 100 may engage in further subsequent anonymous contacts (described below with respect to FIG. 9), or may establish an account with service provider 115. To establish an account, consumer 100 may provide service account information to service provider 115 in association with consumer 100's physical service address. The service account information may include, for example, consumer 100's telephone number, credit/debit card information, current service(s), and other service-related information.

The exemplary process of FIG. 6 has been described as being implemented by service provider device 230. However, in some implementations, the exemplary process of FIG. 6 may be implemented, at least in part, by, or in conjunction with, one or more other devices.

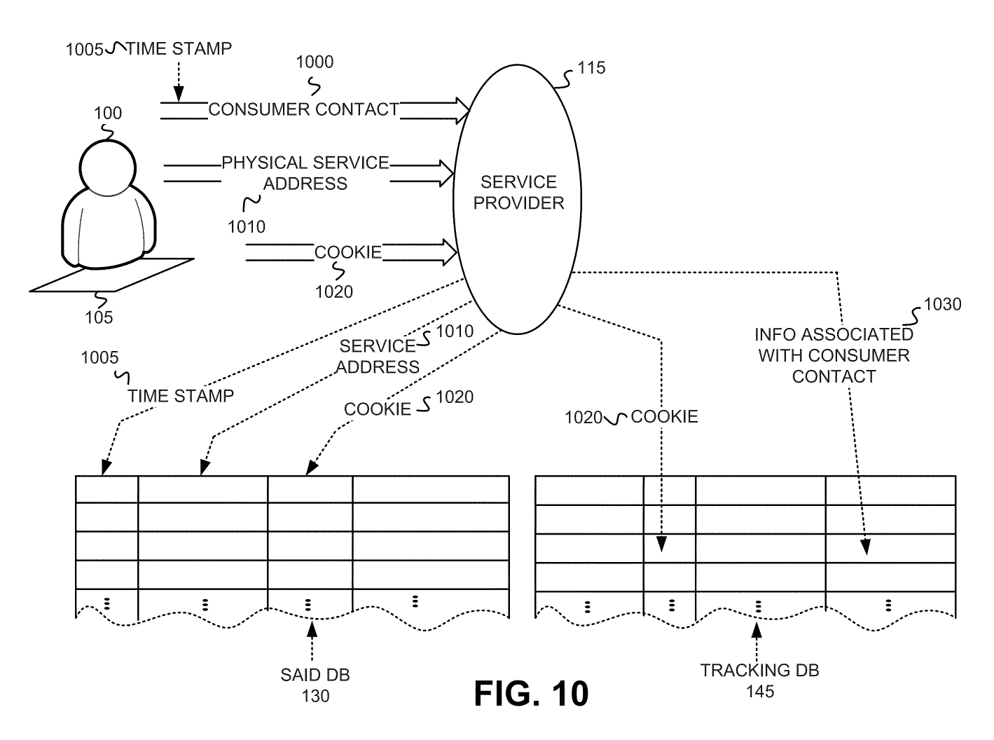

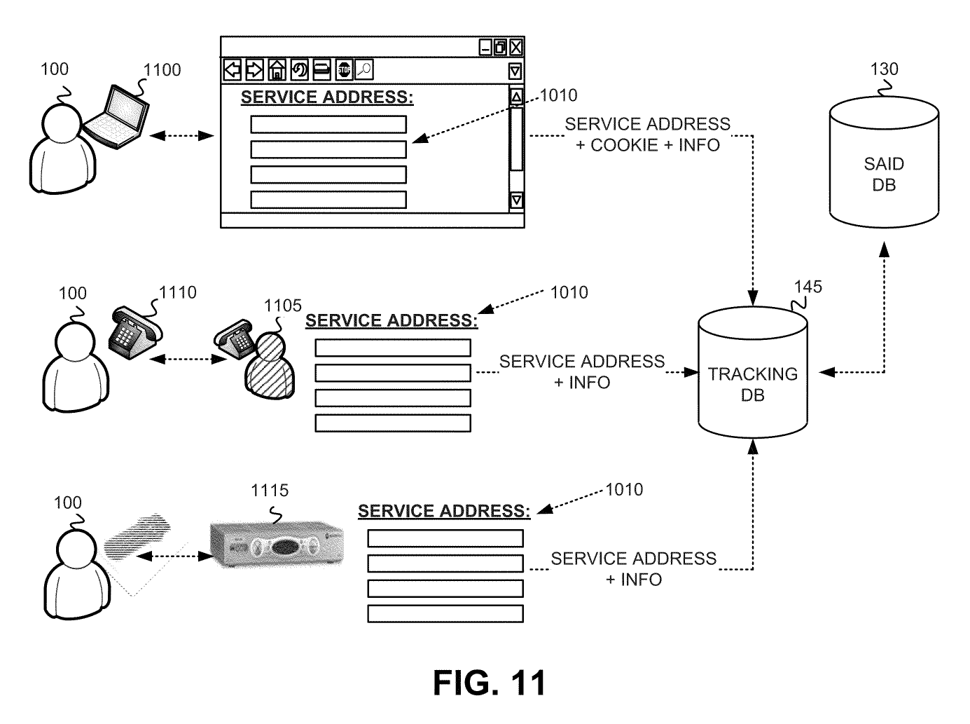

FIG. 9 is a flow diagram that illustrates an exemplary process for tracking a consumer's contacts with a service provider to accumulate information in consumer contacts profile that may be subsequently used by the service provider in ascertaining the consumer's interests and purchasing habits. The exemplary process of FIG. 9 may be implemented by service provider device 230. The exemplary process of FIG. 9 is described below with reference to FIGS. 10 and 11.

The exemplary process may include receiving an anonymous consumer contact (block 900). The contact may include any type of anonymous contact between the consumer and the service provider that is related to a service offered by the service provider. For example, if the service provider is a telephone service provider, than the consumer may contact the service provider to order a new telephone service. In this case, the service contact may include all of the new telephone services that the consumer considers (e.g., call waiting, unlimited long distance, call forwarding, etc.) prior to ordering the new telephone service. As another example, if the service provider is a cable network service provider, than the consumer may contact the service provider to order one or more new services to add to an existing customer account, such as, for example, ordering premium movie channels or premium sports channels. In this case, the service contact may include all of the premium channels that the consumer considers prior to ordering one or more of the premium channels.

As shown in FIG. 10, consumer 100 may initiate a contact 1000 with service provider 115. FIG. 11 further depicts different ways in which consumer 100 may initiate a contact with the service provider. For example, consumer 100 may initiate a contact on-line using a laptop computer 1100. As another example, consumer 100 may initiate a contact by calling a calling center operator 1105 for the service provider using a POTS telephone 1110. As a further example, consumer 100 may initiate a contact using a STB 1115 connected to his cable network service.

Service provider device 230 may request the consumer's physical service address (block 905) and may receive the consumer's physical service address (block 910). FIG. 10 depicts consumer 100 providing a physical service address 1010 of service address 105 to service provider 115. FIG. 11 additionally depicts examples of consumer 100 providing consumer 100's physical service address to the service provider. As shown in FIG. 11, consumer 100 may provide service address 1010 by entering the service address into a web page supplied by service provider device 230. As further shown in FIG. 11, consumer 100 may orally provide service address 1010 to a call center operator 1105, who may then enter service address 1010 into service provider device 230. As also shown in FIG. 11, consumer 100 may provide service address 1010 to the service provider using a remote control and STB 1115.

Service provider device 230 may generate a time stamp (block 915). At the time that service provider device 115 receives the anonymous contact from consumer 100, service provider device 230 may generate a time stamp that includes the time, day and year at which the anonymous contact was received. FIG. 10 depicts a time stamp 1005 being generated at the time that consumer 100 initiates anonymous contact 1000. Service provider device 230 may store the time stamp in SAID DB 130 (block 920). As shown in FIG. 10, service provider 115 (e.g., via service provider device 230) may store the generated time stamp 1005 in time stamp field 435 of SAID DB 130.

Service provider device 230 may obtain the consumer's cookie (block 915) and may store the cookie in SAID DB 130 and tracking DB 145 (block 920). The consumer's cookie may, for example, be obtained in the instance where consumer 100 initiates the contact using a computer. FIG. 10 depicts service provider 115 obtaining consumer 100's cookie 1020 and storing cookie 1020 in cookie field 415 of SAID DB 130 and tracking DB 145. In the situation where the consumer conducts the service contact via the telephone, the consumer's cookie may not be obtained by the call center operator.

Service provider device 230 may add information associated with the contact to consumer contacts profile 520 of tracking DB 145 (block 925). Service provider device 230 may index tracking DB 145 with the physical service address to add information associated with the contact to consumer contacts profile 520. The information associated with the contact may include any type of information related to the consumer's contact with the service provider. For example, if the consumer shops on-line for one or more new services to add to an existing service account with the service provider, the information associated with the contact may include each of the one or more new services that the consumer viewed while on-line. FIG. 10 depicts service provider 115 (e.g., via service provider device 230) storing the information 1030 associated with the contact in tracking DB 145. FIG. 11 further depicts information being stored in tracking DB 145 in the three different examples of consumer 100 initiating a contact with the service provider.

The exemplary process of FIG. 9 has been described as being implemented by service provider device 230. However, in some implementations, the exemplary process of FIG. 9 may be implemented, at least in part, by, or in conjunction with, one or more other devices. The exemplary process of FIG. 9 may be selectively repeated for each contact received at a service provider. The exemplary process of FIG. 9 may, therefore, be repeated for multiple different contacts between a consumer and a service provider. The consumer may have, in certain circumstances, changed physical service addresses between contacts such that previously stored consumer contacts profile information may have to be retrieved and associated with the new physical service address.

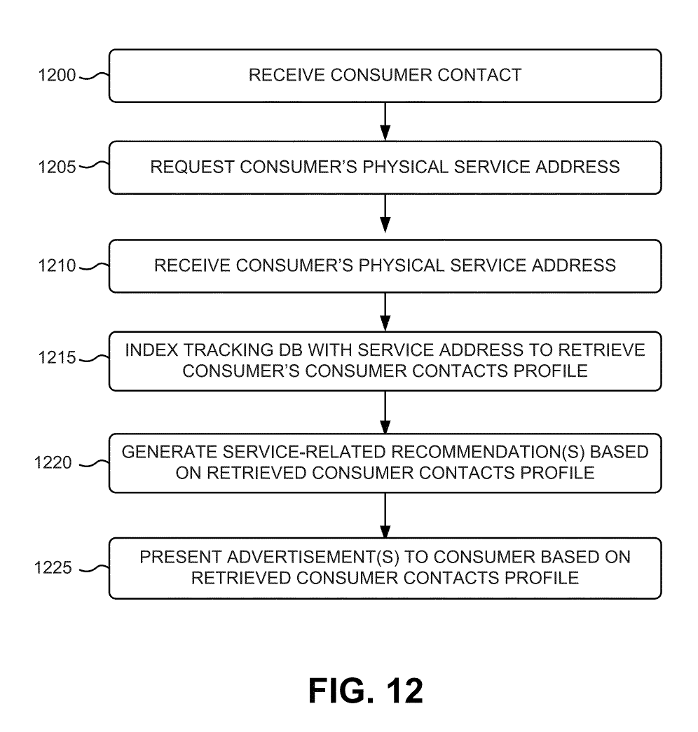

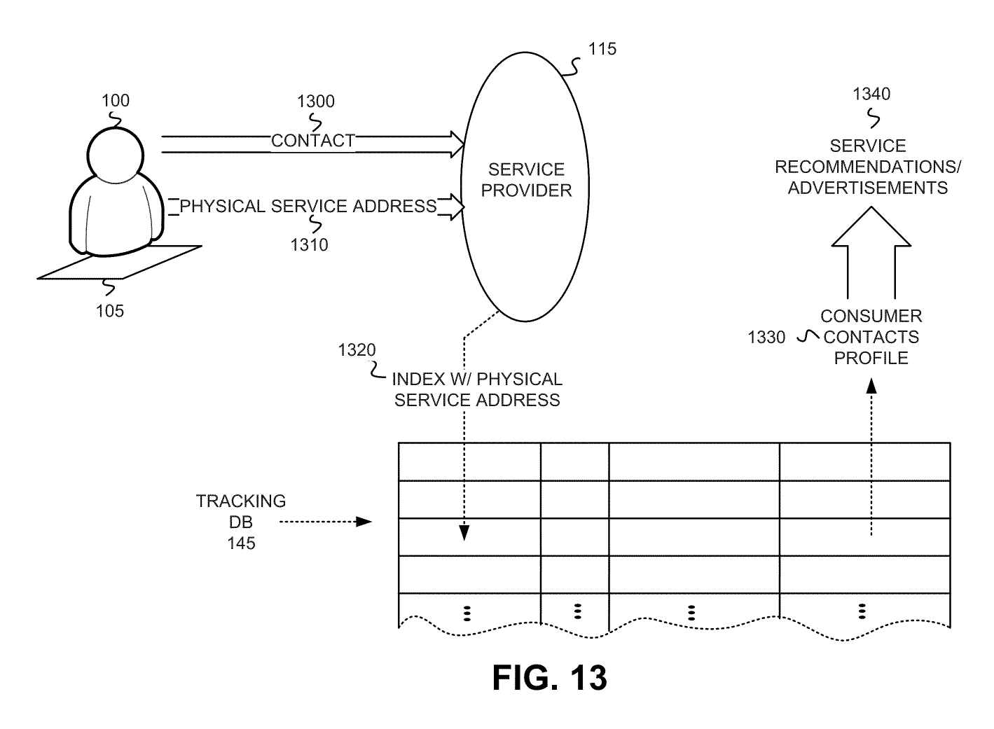

FIG. 12 is a flow diagram that illustrates the use of information stored in tracking DB 145 for ascertaining a consumer's interests or purchasing habits for generating a service-related recommendation(s) and/or for selecting an advertisement(s) for presentation to the consumer. The exemplary process of FIG. 12 may be implemented by service provider device 230. The exemplary process of FIG. 12 is described below with reference to FIG. 13. The exemplary process of FIG. 12 may be selectively repeated for each consumer contact received at service provider device 230.

The exemplary process may include receiving a consumer contact (block 1200). The contact may include any type of anonymous contact between the consumer and the service provider that is related to a service offered by the service provider. As shown in FIG. 13, consumer 100 may initiate a contact 1300 with service provider 115. Service provider device 230 may request the consumer's physical service address (block 1205) and may receive the consumer's physical service address (block 1210). FIG. 13 depicts consumer 100 providing a physical service address 1310 to service provider 115. Consumer 100 may provide service address 1310 by entering the service address into a web page supplied by service provider device 230. Consumer 100 may also orally provide service address 1310 to a call center operator, who may then enter service address 1310 into service provider device 230. Additionally, consumer 100 may provide service address 1310 to the service provider via a remote control and a STB.

Service provider device 230 may index tracking DB 145 with the physical service address to retrieve the consumer's consumer contacts profile 520 (block 1215). FIG. 13 depicts service provider 115 (e.g., via service provider device 230) indexing 1320 tracking DB 145 with physical service address 1310 to retrieve a consumer contacts profile 1330 associated with service address 1310. Service provider device 230 may generate a service-related recommendation(s) based on the contents of the retrieved consumer contacts profile field 520 (block 1220) and may present an advertisement(s) to the consumer based on the retrieved contents of consumer contacts profile field 520 (block 1225). Service provider device 230 may analyze the information retrieved from consumer contacts profile field 520 to identify interests and/or purchasing habits of consumer 100 (or other information, such as the consumer's physical service address itself), and may use those identified interests and/or purchasing habits to generate service or product recommendations to consumer 100, or to select one or more advertisements to present to consumer 100. The selected advertisements may be determined to be relevant to the consumer's identified interests and/or purchasing habits.

The exemplary process of FIG. 12 has been described as being implemented by service provider device 230. However, in some implementations, the exemplary process of FIG. 12 may be implemented, at least in part, by, or in conjunction with, one or more other devices.

The foregoing description of implementations provides illustration and description, but is not intended to be exhaustive or to limit the invention to the precise form disclosed. Modifications and variations are possible in light of the above teachings or may be acquired from practice of the invention. For example, while series of blocks have been described with respect to FIGS. 6, 9 and 12, the order of the blocks may be varied in other implementations. Moreover, non-dependent blocks may be performed in parallel.

Certain features described above may be implemented as “logic” or a “unit” that performs one or more functions. This logic or unit may include hardware, such as one or more processors, microprocessors, application specific integrated circuits, or field programmable gate arrays, software, or a combination of hardware and software.

No element, act, or instruction used in the description of the present application should be construed as critical or essential to the invention unless explicitly described as such. Also, as used herein, the article “a” is intended to include one or more items. Further, the phrase “based on” is intended to mean “based, at least in part, on” unless explicitly stated otherwise.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving a first contact from a consumer, wherein the first contact is related to a service offered by a service provider;
obtaining a physical service address associated with the consumer;
adding information associated with the contact to a consumer contacts profile associated with the physical service address; and
using the consumer contacts profile to generate a service-related recommendation, or to select an advertisement, for presentation to the consumer.

2. The method of claim 1, wherein the contact comprises an initial service request that requests establishment of a service with the consumer at the physical service address.

3. The method of claim 1, further comprising:
receiving a second contact from the consumer,
wherein the consumer contacts profile is used to generate the service-related recommendation, or to present the advertisement, based on receipt of the second contact.

4. The method of claim 1, wherein the service provider comprises an entity that requires knowledge of a consumer's physical service address to provide a service to the consumer.

5. The method of claim 4, wherein the service provider comprises a mail delivery service provider, a package delivery service provider, a cable service provider, a phone service provider, an electricity service provider, a gas service provider, a water service provider, an Internet service provider, or a video delivery network service provider.

6. The method of claim 1, wherein the first contact is received at the service provider via an on-line contact over the Internet, a voice contact over a telephone network, or an electronic contact via a set-top box and a cable network.

7. The method of claim 1, wherein the physical service address comprises a residential or commercial geographic address at which a service is provided by the service provider.

8. The method of claim 1, wherein the information associated with the first contact comprises any type of information related to the consumer's contact with the service provider.

9. The method of claim 8, wherein the consumer contacts profile comprises a history of the consumer's contacts with the service provider that is useful in identifying the consumer's interests or purchasing habits.

10. A device, comprising:
an input device;
a communication interface coupled to a network;
a processing unit configured to:
receive, via the communication interface, a first contact from a consumer, wherein the first contact is related to a service offered by a service provider, and wherein the service provider comprises a mail delivery service provider, a package delivery service provider, a cable service provider, a phone service provider, a utility service provider, an Internet service provider, or a video delivery network service provider,
obtain a physical service address associated with the consumer,
add information associated with the first contact to a consumer contacts profile associated with the physical service address, and
use the consumer contacts profile to generate a service-related recommendation, or to select an advertisement, for presentation to the consumer.

11. The device of claim 10, wherein the first contact comprises an initial service request that requests establishment of a service with the consumer at the physical service address.

12. The device of claim 10, further comprising:
receiving a second contact from the consumer,
wherein the consumer contacts profile is used to generate the service-related recommendation, or to present the advertisement, based on receipt of the second contact.

13. The device of claim 10, wherein the first contact is received by the service provider via an on-line contact over the Internet, a voice contact over a telephone network, or an electronic contact via a set-top box and a video network.

14. The device of claim 10, wherein the physical service address comprises a residential or commercial geographic address at which a service is provided by the service provider.

15. The device of claim 10, wherein the information associated with the first contact comprises any type of information related to the consumer's contact with the service provider.

16. The device of claim 10, wherein the consumer contacts profile comprises a history of the consumer's contacts with the service provider that is useful in identifying the consumer's interests or purchasing habits.

17. A method, comprising:
obtaining a first physical service address associated with a consumer;
tracking a first contact between the consumer and the service provider based on the first physical service address, wherein the first contact is conducted via a first network and is related to a service offered by the service provider;
obtaining a second physical service address associated with the consumer;
tracking a second contact between the consumer and the service provider based on the second physical service address, wherein the second contact is conducted via a second network and is related to the service offered by the service provider;
storing information associated with the first and second contacts in a consumer contacts profile included in a tracking database based on the first and second physical service addresses; and
generating a service-related recommendation, or selecting an advertisement, for presentation to the consumer based on the consumer contacts profile.

18. The method of claim 17, wherein the first physical service address is a same address as the second physical service address.

19. The method of claim 17, wherein the first physical service address is a different address than the second physical service address.

20. The method of claim 17, wherein the first network is a same network as the second network.

21. The method of claim 17, wherein the first network is a different network than the second network.

22. The method of claim 17, wherein the first contact is received at the service provider via an on-line contact over the Internet, a voice contact over a telephone network, or an electronic contact via a set-top box and a video network.

23. The method of claim 17, wherein the first and second physical service addresses comprise residential or commercial geographic addresses at which a service is provided by the service provider.

24. The method of claim 17, wherein the consumer contacts profile comprises a history of the consumer's contacts with the service provider that is useful in identifying the consumer's interests or purchasing habits.
